(19) United States
(12) Patent Application Publication
(10) Pub. No.: US 2026/0214421 A1
(43) Pub. Date: Jul. 23, 2026

(54) METHOD FOR PROCESSING A VEHICLE-TO-X MESSAGE, METHOD FOR PROCESSING AN ACKNOWLEDGEMENT MESSAGE, AND VEHICLE-TO-X COMMUNICATION MODULE

(71) Applicant: Continental Automotive Technologies GmbH, Hannover (DE)

(72) Inventors: Sebastian Strunck, Niedernhausen (DE); Marc Menzel, Weimar (Lahn) (DE)

(73) Assignee: Continental Automotive Technologies GmbH, Hannover (DE)

(21) Appl. No.: 19/141,525

(22) PCT Filed: Dec. 12, 2023
(86) PCT No.: PCT/DE2023/200253

§ 371 Date: Jun. 20, 2025

(30) Foreign Application Priority Data
Dec. 23, 2022 (DE) 10 2022 214 393.0

(51) Int. Cl. H04W 4/40; H04L 1/16

(52) U.S. Cl. CPC H04W 4/40; H04L 1/16

(57) ABSTRACT

The disclosure relates to a method for processing a vehicle-to-X message, wherein a vehicle-to-X message is received, information items are extracted therefrom, and an acknowledgement message containing such information items is sent. The disclosure furthermore relates to an associated method for processing an acknowledgement message and to an associated vehicle-to-X communication module.

### CROSS REFERENCE TO RELATED APPLICATIONS

This U.S. patent application claims the benefit of PCT patent application No. PCT/DE2023/200253, filed Dec. 12, 2023, which claims the benefit of German patent application No. 10 2022 214 393.0, filed Dec. 23, 2022, both of which are hereby incorporated by reference.

### TECHNICAL FIELD

The disclosure relates to a method for processing a vehicle-to-X message, to a method for processing an acknowledgement message and to an associated vehicle-to-X communication module.

### BACKGROUND

Vehicle-to-X communication is currently in the phase of standardization, development and introduction. Vehicle-to-X communication is intended in principle to make it possible for vehicles and infrastructure devices to exchange information items among one another. In this case, it is known to send vehicle-to-X messages which include the current position or the current speed of a vehicle, for example.

### SUMMARY

It has been recognized that although vehicle-to-X communication in the form known hitherto may contribute to traffic safety, it does not enable certain functions to be realized. It is therefore an object of the disclosure to provide a method for processing a vehicle-to-X message that is of alternative or better design compared with known designs, for example enables further functionalities. It is furthermore an object of the disclosure to provide an associated further method and an associated vehicle-to-X communication module. According to the disclosure, this is achieved by methods and a vehicle-to-X communication module as claimed in the respective main claims. Configurations may be gathered from the respective dependent claims, for example. The content of the claims is incorporated in the content of the description by express reference.

The disclosure relates to a method for processing a vehicle-to-X message. The method comprises the following steps: receiving the vehicle-to-X message, extracting one information item or a plurality of information items from the vehicle-to-X message, and sending an acknowledgement message containing one or a plurality of the extracted information items.

A reception acknowledgement for a vehicle-to-X message may be given by means of such a method. Consequently, in a vehicle-to-X communication, a sender not only indicates specific states such as for example its own position, its own course or its own speed, but it also obtains feedback about whether the information has been correctly received elsewhere. This allows the use of vehicle-to-X communication for safety-critical applications, too, which for example require certainty that a vehicle-to-X message has been correctly received elsewhere. For example, this may be used, when approaching traffic lights, to make sure that the traffic lights have correctly received the position of the vehicle. This enables better reliability of information items communicated by the traffic lights, for example, such that the traffic lights may better control the flow of traffic at an intersection.

The vehicle-to-X message may originate in particular from another vehicle-to-X participant. In particular, it may originate from a vehicle. However, it may also originate from an infrastructure device such as for example a traffic light installation or a road side unit. A vehicle-to-X message typically contains one or a plurality of information items relating for example to the position, speed or course of an object, to hazard states such as for example broken down vehicles, to traffic information, to surroundings information or to state information such as for example concerning a traffic light installation or some other traffic influencing installation. Such information items may be extracted after a vehicle-to-X message has been received. They are wholly or at least partly included in an acknowledgement message, such that the sender that may receive the acknowledgement message may directly check the correct reception of the respective information item. In this case, the acknowledgement message may be designed such that it contains only information items from one received vehicle-to-X message. However, the acknowledgement message may also be designed such that it contains information items concerning a plurality of received vehicle-to-X messages. The acknowledgement message may be sent after the respective reception of a vehicle-to-X message, for example. Alternatively, it may also be sent at specific time intervals, for example. In this case, for example, information items from a plurality of vehicle-to-X messages which are received between the respective sending times may be combined in one acknowledgement message. The time intervals may be for example at least 0.1 s or at least 0.5 s and/or at most 1.5 s or at most 1 s.

Extracting information from a message is understood to mean, in particular, that such information is taken from the message, without further processing of the whole message during the extracting. The extracted information item then becomes part of a new message. This is differentiated from simple relaying of complete messages.

In particular, provision may be made for at least one extracted information item to be an extracted location information item. An extracted location information item is understood to mean a location information item which has been extracted from a vehicle-to-X message. The extracted location information item is thus differentiated from a detected location information item, described below.

A unit carrying out the method may detect in particular a detected location information item of a sender of the vehicle-to-X message. In this case, a detected location information item is understood to mean a location information item which has not been extracted from a vehicle-to-X message, but rather which has been detected independently thereof; for example, it may have been detected using environment sensors. The extracted location information item may be compared with the detected location information item, in particular. As a result, it is possible to ascertain how well the two location information items match and/or how much reliance there is on the respective location information item.

In particular, it may be provided that in response to a deviation between extracted location information item and detected location information item which is at least equal to a threshold value, an error message is output. As a result, it is possible to indicate that the location information items present are not reliable. The error message may be for example a visual or an acoustic warning message to a driver of a vehicle. Alternatively, it is also possible to output an error message which is output for example to some other functional unit or to some other function, such that a subsequent function such as for example control of a traffic light installation or control of a vehicle is informed about the location information item not being reliable. The error message may contain for example the deviation or a variable indicating the deviation. A weighting of information items may also be changed, for example reduced. Subsequent units may thus be made aware of the reduced reliability. It is likewise possible to reduce a speed of a vehicle, for example to such an extent that exclusively taking account of local sensors is sufficient. This may be realized for example by a suitable message being sent.

It may also be provided that in response to a deviation between extracted location information item and detected location information item which is less than the threshold value, a positive message is output. This enables a positive acknowledgement of a location determination.

The acknowledgement message may contain in particular the error message and/or the positive message. Other vehicle-to-X participants may thus be informed about the result.

In particular, it may be provided that depending on the extracted location information item a derived location information item is calculated which represents a location indicated by the extracted location information item preferably in a different representation. For example, the extracted location information item may specify a location in global coordinates, and the derived location information item may specify the location for example in such a way that a lane and/or a distance to a reference point and/or an associated angle are/is specified. For example, the derived location information item may be specified in a Frenet coordinate system. For example, road, lane, transverse deviation and/or longitudinal information may be used or specified as coordinates. The acknowledgement message may contain in particular the derived location information item. This allows further evaluations at the receiver of the location information item.

According to one embodiment, the acknowledgement message contains a detected location information item of the sender of the vehicle-to-X message. As a result, the sender may be informed about what location a unit carrying out the method has detected from the sender. The sender may compare this location information item with a different location determination and may thus ascertain how reliable the detected and/or obtained location information item is. High deviations between different location information items indicate that at least one of the location information items is not reliable. For example, a detected location information item of the sender may be contained in a MAP message. To put it another way, an acknowledgement message and a MAP message may be combined. An acknowledgement message may locate communicated position data in a MAP message, for example. For example, a number of a lane and/or a distance from a stop line or some other reference point or some other reference line may be specified. This also applies to a derived location information item. A MAP message may contain information items about surroundings, in particular. Information items of this type may be present in the form of a map, in particular. They may include for example where roads are situated and how the latter extend. As an alternative to a MAP message, a SPaT message may also be used, for example. That is understood to be a “Signal Phase and Timing” message containing traffic light phases or information items about traffic light phases.

In particular, the acknowledgement message may contain information items from a plurality of received vehicle-to-X messages. This enables a joint acknowledgement for these received vehicle-to-X messages. The number of messages to be sent in total may be significantly reduced as a result, in particular in comparison with an acknowledgement message being sent after every received message. In particular, acknowledgement messages of this type may be sent at defined time intervals, as already described further above.

The acknowledgement message may contain for example timestamps concerning one or a plurality of received vehicle-to-X messages. Such a timestamp may be a time information item contained in the respective vehicle-to-X message and/or this may involve a time at which the respective vehicle-to-X message was received. This gives receivers of the acknowledgement message the opportunity to check their own time base and to evaluate the correct vehicle-to-X communication. A timestamp or a time information item may also indicate a difference time. Such a difference time may be determined for example between a time of reception of a message and a time of reception of a preceding message. Such a difference time may also be referred to as a repetition time. It may serve in particular to check a connection quality. For example, a vehicle may thus check how many of its own messages have not, or not completely, been received. A possible further information item which may be contained in an acknowledgement message is for example a difference between the reception of a respective cooperative awareness message (CAM) and the sending of an acknowledgement message. As a result, the receiver may recognize how old the original information is.

The acknowledgement message may include in particular information items relating to a traffic light phase and/or an action recommendation. As a result, it is possible to send more extensive information items with an acknowledgement message, which information items need not necessarily originate from the received vehicle-to-X messages. Information items relating to a traffic light phase may include for example the information as to whether a traffic light in a specific direction is currently red, amber or green, and/or they may include information items about when a change in the signal should be expected. A warning for a vehicle may also be contained. An action recommendation may be for example a recommendation to a vehicle to brake or to accelerate or to maintain its speed in order to optimize the flow of traffic at a traffic light or in order to still reach a specific traffic light phase. The action recommendation may also be for example a recommendation to change a lane.

The acknowledgement message may include in particular an information item about whether the sender of the vehicle-to-X message has been detected by a unit carrying out the method. This may involve for example detecting as already described further above with reference to the detected location information item. As a result, the receiver of the acknowledgement message, for example a vehicle, knows whether it has been detected, and optionally also whether it has been detected correctly. This may give a vehicle for example the feedback as to whether the traffic light is informed about the presence of the vehicle and takes this into account for example when controlling the flow of traffic.

The acknowledgement message may include in particular an information item about how many vehicle-to-X messages have been received since the last acknowledgement message. The acknowledgement message may also include in particular an information item about what vehicle-to-X messages have been received since the last acknowledgement message. The latter information item may be implemented for example in the form of a list which contains the received vehicle-to-X messages or contains at least a respective reference to a corresponding vehicle-to-X message. References of this type may include for example a portion of the contained information items or may be or include an identification of the respective vehicle-to-X message. This may in particular also relate to different senders.

The vehicle-to-X message may for example be a message that provides vehicle information items of the sender, and/or be a cooperative awareness message (CAM) and/or a basic safety message (BSM). Such a cooperative awareness message or basic safety message typically includes information items such as a location, a speed and/or a course of a vehicle. These information items typically serve to provide general information about the current state of a vehicle, such that other road users may take this into account and may avoid collisions, for example. However, the acknowledgement message may also be used for all other kinds of vehicle-to-X messages.

The method may be carried out by an infrastructure device, in particular. Such an infrastructure device may be a traffic light installation, in particular. The latter affords numerous situations in which a reception acknowledgement for vehicle-to-X messages is advantageous. However, the method may in principle also be carried out by other infrastructure devices, by a road side central unit or by vehicles. In principle, it may be carried out on the part of every participant in the vehicle-to-X communication.

The disclosure furthermore relates to a method for processing an acknowledgement message. The method comprises the following steps: receiving an acknowledgement message preferably sent by means of a method as described herein and/or preferably containing one information item or a plurality of information items, and extracting one information item or a plurality of information items from the acknowledgement message.

An acknowledgement message sent by some other unit may be processed by such a method. In particular, information items contained therein may be extracted. These information items may then be used for further purposes. With regard to the method for sending an acknowledgement message, it is possible to have recourse to all embodiments and variants described herein. In principle, the reception of one or more other messages is acknowledged by an acknowledgement message, which differentiates such an acknowledgement message from other types of messages.

In particular, an identification, for example a number, contained in the acknowledgement message, may be compared with a local list of identifications sent. As a result, it is possible to recognize whether a message itself sent is acknowledged by the acknowledgement message.

In particular, provision may be made for at least one extracted location information item to be extracted from the acknowledgement message. Therefore, this typically involves a location information item contained in the acknowledgement message. Such a location information item is typically based on the fact that a vehicle-to-X participant that carries out the method for processing an acknowledgement message has determined a derived location information item, for example as described elsewhere herein. Using the terminology of the method which sends the acknowledgement message, therefore, this involves a derived location information item; using the terminology of the method for processing the acknowledgement message, this involves an extracted location information item. The extracted location information item may be compared with a detected location information item. A detected location information item, in the case of a vehicle, for example, may originate from satellite navigation or some other kind of location determination. It may be compared with the extracted location information item, such that it is possible to assess how reliable the location information items are.

Each sender for example primarily itself ascertains its location information items, and the latter is then part of the CAM/BSM, or the sender of the acknowledgement message in addition concomitantly sends its location information item, for example with reference to the center of the traffic light installation or of a simple sender.

In addition, the creator of the acknowledgement message may also send an acknowledgement if the location of an object is for its part acknowledged as well. In particular, it may be provided that in response to a deviation between extracted location information item and detected location information item which is at least equal to a threshold value, an error message is output. Thus, also in the case of a unit that receives the acknowledgement message, it is possible to react to a deviation that is possibly excessively large. Reference should be made to the explanations in this regard that have already been given further above. Conversely, an information item sent by a road user may also be acknowledged by sensor detection.

In particular, a traffic light phase and/or an action recommendation may be extracted from the acknowledgement message. The traffic light phase and/or the action recommendation may be verified by local information items, in particular. Local information items of this type may originate for example from one or more cameras, one or more environment sensors or one or more radar devices of a vehicle. A verification may mean in particular examining whether the traffic light phase matches the local information, i.e. that for example a traffic light phase extracted from the acknowledgement message corresponds to a traffic light phase detected by camera. Moreover, it is possible for example to examine whether an action recommendation is feasible at all in view of a detected environment state, for example whether a lane change, an acceleration or braking is feasible in view of the surrounding road users detected.

The disclosure furthermore relates to a vehicle-to-X communication module. The latter is configured to carry out a method as described herein. With regard to the method, it is possible to have recourse to all embodiments and variants described herein.

In the case of driving functions in vehicles which include messages from a vehicle-to-X communication as a source of information, these may typically be used only as a source of information for warnings in the case of known designs. In some situations, however, it may transpire for example that the information items obtained by way of vehicle-to-X communication constitute the only available source of information. For example, this occurs in the case of traffic light installations which are equipped with vehicle-to-X communication and in which a camera-based traffic light phase detection is not possible on account of the circumstances. This may be the case for example against the light or when a camera is at an unfavorable angle with respect to the light installation. A safeguarded vehicle-to-X communication may be used at this point. The acknowledgement message described herein, for example, may be used for this purpose.

In particular, received messages such as for example received cooperative awareness messages may be acknowledged by the procedure described herein. For this purpose, for example a vehicle-to-X participant such as for example a traffic light installation may send a list with object IDs which have sent a CAM and have been received by the traffic light installation or some other vehicle-to-X participant. Part of this acknowledgement message may be that an array element with one or more of the following contents is sent for each participant: object ID, timestamp (or delta time) since the last received message, position in relation to a MAP message of an infrastructure device (for example what road segment with what offset), position acknowledged by infrastructure-side sensor system (e.g. yes, no, no detection possible), action recommendation, in particular with reference to a traffic light status, number of CAMs received since the last sending cycle, delta time since the last message.

The following message contents may also be encoded in a CPM (Cooperative Perception Message). If there are errors in this message, for example the following content may help to locate the equipped participants. The infrastructure thus functions for example as a repeater for a part of the information. This may involve for example one or a plurality of the following information items: heading from the CAM, position from the CAM, speed from the CAM, acceleration from the CAM, optionally confidences.

The procedure described herein results in particular in acknowledgement that for example a traffic light installation has perceived a specific vehicle at a particular location. Furthermore, the last reception of a message from such a participant may be provided with a delta timestamp. The own vehicle may thus determine what probability of reception a message has. A position in relation to a map used as a MAP message may be an indication of the accuracy of a vehicle-internal map. This may also enable a verification with a map sent in the MAP message. Furthermore, there may be an indication of the positional accuracy of the own localization. The position sent in a CAM message may be assessed by an infrastructure, and thus from outside the own position. This may be evaluated as independent checking of the information provided.

A further signal may be that an action recommendation is sent on the part of the infrastructure, for example taking into account the traffic light phases and the communicated speed. This may be compared by the vehicle's own assessment of the signal detection of the traffic light. A redundant procedure for traffic light phase communication may also be provided as a result. Moreover, checkability may be provided. In one case an infrastructure may perform computation or carry out message processing, and in another case the vehicle.

Furthermore, it is possible to compare an own environment perception with relevant vehicles. Such a list may be sent for example as part of SPaT/MAP, as part of a message for collective perception (e.g. CPM, RSM or SDSM) or as an own message.

In this case, the optional message contents or contents of messages may help to perform the recognition and prediction of surrounding participants.

It is thus possible in particular to provide a message which, in a very safety-critical area, enables a radio channel to the infrastructure device to be checked directly at both ends. Furthermore, it is possible to provide position checking by an interpretation of the sent information items by an infrastructure which makes a reference to the road topology.

### BRIEF DESCRIPTION OF THE DRAWINGS

A person skilled in the art will gather further features and advantages from the embodiment described below with reference to the appended drawing, in which:

FIG. 1: shows an intersection with vehicles.

### DETAILED DESCRIPTION

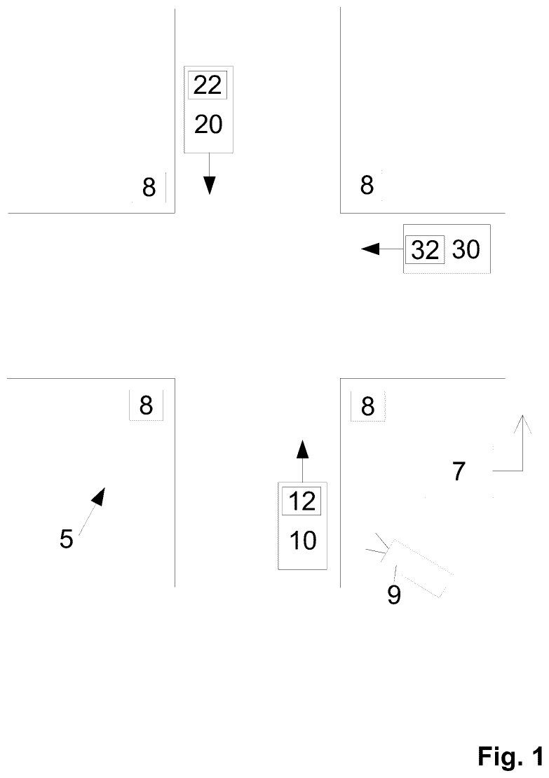

FIG. 1 purely schematically shows an intersection 5, at which two roads intersect. A first vehicle 10, a second vehicle 20 and a third vehicle 30 are situated on these roads. The first vehicle 10 comprises a first vehicle-to-X communication module 12. The second vehicle 20 comprises a second vehicle-to-X communication module 22. The third vehicle 30 comprises a third vehicle-to-X communication module 32. This enables the vehicles 10, 20, 30 to participate in the vehicle-to-X communication. This means in particular that they may send and receive vehicle-to-X messages.

A total of four light signal installations 8 are installed at the intersection 5. These indicate to the vehicles 10, 20, 30 whether or not crossing of the intersection 5 is currently allowed. This is done as usual by the display of red, green and amber light signals.

Furthermore, an infrastructure device 7 is provided, which is designed to participate in the vehicle-to-X communication. Moreover, the infrastructure device 7 is in contact with the light signal installations 8. In particular, the light signal installations 8 communicate to the infrastructure device 7 the respective traffic light phases and subsequently planned switching times.

Via their respective vehicle-to-X communication module 12, 22, 32, the vehicles 10, 20, 30 constantly communicate vehicle-to-X messages, specifically in particular cooperative awareness messages, which contain current information items about location, speed and course of the respective vehicle 10, 20, 30. These are received and evaluated by the infrastructure device 7. The infrastructure device 7 gathers the information items contained in the received vehicle-to-X messages and in each case collects the information items obtained within one second. After each second has elapsed, an acknowledgement message is sent by the infrastructure device 7, said acknowledgement message containing the received information items and also indications of the respective sender. This acknowledgement message may be received again by the vehicles 10, 20, 30, such that the vehicles 10, 20, 30 are informed about whether the important information items have been correctly received by the infrastructure device 7.

Furthermore, a location determination may be checked. For this purpose, the infrastructure device 7 is connected to a schematically illustrated environment sensor system 9, which can visually detect the vehicles 10, 20, 30. It is possible to determine therefrom a detected location information item specifying a position of the respective vehicle 10, 20, 30 in a coordinate system used on the infrastructure side. This detected location information item may be compared with an extracted location information item that has been extracted from a vehicle-to-X message obtained from a vehicle 10, 20, 30. If the deviation between the two location information items is less than a threshold value, then a positive message may be issued; if the deviation is greater than a threshold value, then an error message may be issued. Messages of this type may be included in an acknowledgement message.

Furthermore, a derived location information item may be determined from the detected location information item. The derived location information item represents the location information in a different representation. For example, it is possible to specify on what lane a vehicle is situated at what distance from a reference point. This derived location information item may be concomitantly included in an acknowledgement message and be sent to the vehicles 10, 20, 30. The vehicles 10, 20, 30 each have their own possibilities for location determination, in particular by way of satellite navigation, and may thus carry out a comparison of the location information items. This may give an indication of how accurate the respective location determination currently is.

The infrastructure device 7 may give in particular instructions to the vehicles 10, 20, 30 which for example can instruct the vehicles 10, 20, 30 to brake or to accelerate in order to reach specific traffic light phases. If the respective vehicle 10, 20, 30 recognizes from the received acknowledgement message that the vehicle-to-X communication is functioning bidirectionally in an entirely satisfactory way, instructions of this type may be regarded as reliable and may accordingly be implemented. However, if discrepancies are recognized, for example because information items are not correctly acknowledged or because the location information item is unreliable, the implementation of instructions of this type may be dispensed with.

In general, it should be pointed out that vehicle-to-X communication is understood to mean in particular a direct communication between vehicles and/or between vehicles and infrastructure devices. By way of example, it may thus be vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which should therefore be differentiated from other solutions based on a mobile radio network, for example. By way of example, a vehicle-to-X communication can be effected using the IEEE 802.11p or IEEE 1609.4 standard. Other examples of communication technologies include LTE-V2X, 5G-V2X, C-V2X, WLAN, WiMax, UWB or Bluetooth. A vehicle-to-X communication may also be referred to as C2X communication. The subareas may be referred to as C2C (car-to-car) or C2I (car-to-infrastructure). However, the invention explicitly does not exclude vehicle-to-X communication with switching via a mobile radio network, for example.

Aforementioned steps of the method according to the disclosure may be carried out in the order indicated. However, they may also be carried out in a different order, insofar as is technically expedient. The method according to the disclosure may be carried out in one of its embodiments, for example with a specific combination of steps, in such a way that no further steps are carried out. However, in principle, further steps may also be carried out, even steps that have not been mentioned.

It should be pointed out that features may be described in combination in the claims and in the description, for example in order to facilitate understanding, even though said features may also be used separately from one another. A person skilled in the art recognizes that such features, independently of one another, may also be combined with other features or combinations of features.

Back-references in dependent claims may characterize preferred combinations of the respective features but do not exclude other combinations of features.

1. A method for processing a vehicle-to-X message, the method comprising:
receiving the vehicle-to-X message,
extracting one information item or a plurality of information items from the vehicle-to-X message, and
sending an acknowledgement message containing one or a plurality of the extracted information items.

2. The method as claimed in claim 1,
wherein at least one extracted information item is an extracted location information item,
wherein a unit carrying out the method detects a detected location information item of a sender of the vehicle-to-X message, and
wherein the extracted location information item is compared with the detected location information item.

3. The method as claimed in claim 2,
wherein in response to a deviation between extracted location information item and detected location information item which is at least equal to a threshold value, an error message is output.

4. The method as claimed in claim 1,
wherein at least one extracted information item is an extracted location information item,
wherein depending on the extracted location information item a derived location information item is calculated which represents a location indicated by the extracted location information item in a different representation, and
wherein the acknowledgement message contains the derived location information item of the sender of the vehicle-to-X message.

5. The method as claimed in claim 1, wherein the acknowledgement message contains information items from a plurality of received vehicle-to-X messages.

6. The method as claimed in claim 1, wherein the acknowledgement message contains timestamps concerning one or a plurality of received vehicle-to-X messages.

7. The method as claimed in-any claim 1, wherein the acknowledgement message includes information items relating to a traffic light phase and/or an action recommendation.

8. The method as claimed in claim 1, wherein the acknowledgement message includes an information item about whether the sender of the vehicle-to-X message has been detected by a unit carrying out the method.

9. The method as claimed in claim 1, wherein the acknowledgement message includes an information item about how many vehicle-to-X messages and/or what vehicle-to-X messages have been received since the last acknowledgement message.

10. The method as claimed in claim 1, wherein the vehicle-to-X message is a message that provides vehicle information items of the sender, and/or is a cooperative awareness message or a basic safety message.

11. The method as claimed in claim 1, which is carried out by an infrastructure device.

12. A method for processing an acknowledgement message, the method comprising:
receiving an acknowledgement message containing one information item or a plurality of information items, and
extracting one information item or a plurality of information items from the acknowledgement message.

13. The method as claimed in claim 12,
wherein at least one extracted location information item is extracted from the acknowledgement message, and
wherein the extracted location information item is compared with a detected location information item.

14. The method as claimed in claim 13,
wherein in response to a deviation between extracted location information item and detected location information item which is at least equal to a threshold value, an error message is output, and/or a weighting of information items is changed and/or a vehicle speed is reduced.

15. A vehicle-to-X communication module configured to carry out a method, the method comprising:
receiving the vehicle-to-X message,
extracting one information item or a plurality of information items from the vehicle-to-X message, and
sending an acknowledgement message containing one or a plurality of the extracted information items.

16. The method as claimed in claim 2, wherein in response to a deviation between extracted location information item and detected location information item which is less than the threshold value, a positive message is output.

17. The method as claimed in claim 2, wherein the acknowledgement message contains the error message and/or the positive message.
